(19) United States
(12) Patent Application Publication
(10) Pub. No.: US 2007/0280105 A1
(43) Pub. Date: Dec. 6, 2007

(54) Enabling client QoS middle layer based on application recognition

(76) Inventors: Omri Barkay, Yishay (IL); Omer Ben-Shalom, St. Rishon (IL)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/444,889

(22) Filed: May 31, 2006

(51) Int. Cl. H04L 12/26; H04J 3/16

(52) U.S. Cl. 370/229; 370/469

(57) ABSTRACT

A method and apparatus for providing Quality of Service (QoS) on a per application basis is described herein. A QoS policy is established for a specific application that is executable on a client of a network. The QoS policy is distributed to the client. Packet traffic originating from the application is filtered based at least in part on the QoS policy.

### FIELD

Embodiments of the invention relate to quality of service as applied to network traffic, and more particularly to quality of service for particular network applications.

### BACKGROUND

The need to differentiate between different classes of network traffic is becoming more significant. Different applications have different network requirements. Some applications require a guaranteed throughput while other applications require limits on the number of dropped packets, transmission delay, jitter, out-of-order packet delivery, and other errors.

Quality of Service (QoS) refers generally to the probability that a network will meet the requirements of various applications and services. For example, Voice over Internet Protocol (VoIP) is a latency sensitive application. Thus, a VoIP application may require a level of QoS that guarantees packet delivery within a certain amount of time. Other applications have may have similar QoS requirements.

Differentiated Services, or DiffServ, is one method of trying to guarantee QoS on large networks such as the Internet. Generally, with DiffServ, prioritization is determined on a per hop/per packet basis using packet header markings. DiffServ avoids simple priority tagging and depends on more complex policy or rule statements to determine how to forward a given network packet. For a given set of packet travel rules, a packet is given one of 64 possible forwarding behaviors—known as per hop behaviors (PHBs).

To distinguish classes of traffic, packets must be classified. With DiffServ, each packet is marked with a DiffServ Code Point (DSCP), which modifies the IP header of the packet according to the class of traffic. However, this approach is problematic. First, packets are marked at the transport layer (or a lower level layer) of the system. More specifically, packets are marked based on the port through which the packets are transmitted by an application. Typical transport layer ports include Transmission Control Protocol (TCP) ports and User Datagram Protocol (UDP) ports.

For example, the standard File Transfer Protocol (FTP) port is TCP port 21. Thus, a user seeking to access an FTP server would use TCP port 21. Therefore, classifying an FTP application with a particular priority level would simply require marking all packets sent on TCP port 21 according to the specified priority level.

However, many applications (e.g. soft-phone applications) do not have a standard or pre-defined port for network communication. Many soft-phone applications, for example, use dynamic port allocation. A given soft-phone application may have a range of ports (perhaps as many as 16,000) that it may use. Soft-phones, which operate in a VoIP environment, are latency sensitive applications, generally requiring a high priority classification for their packets. Thus, in order to guarantee that all soft-phone packets receive the necessary high priority classification, traffic on the entire range of ports available to the soft-phone application must be treated as high priority traffic. However, in certain situations a soft-phone application may not be using one of these ports. Meanwhile, other applications that do not require a high priority classification may use one of these ports and erroneously receive high priority status.

One possible solution for ensuring the appropriate level of QoS at the application level is to allow traffic (i.e. packet data) from applications to be self-marked/classified. However, this approach is problematic for at least two reasons. First, many applications are not QoS aware/enabled and are unable to self-classify traffic. The second problem is that self-classifying requires self-policing. In other words, users and/or application developers must be trusted to mark traffic according to the classification system and/or priority scheme of the network. However, allowing self-classification would allow every application to request that its traffic be given high priority. If every application self-selects high priority status, the flow of traffic on the network would be no different than the flow of traffic on a network that provides no QoS at all.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 illustrates an embodiment of the invention having a QoS agent.

FIG. 2 illustrates an embodiment of the invention that includes a policy server.

FIG. 3 is a diagram illustrating an embodiment of the invention.

FIG. 4 is a flow diagram according to an embodiment of the invention.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

In one embodiment of the invention, an application sub-layer is created that allows a system to define QoS parameters for individual applications. As used herein, an application refers to a program or group of programs designed for end users. Applications and/or applications software “sits on top” of systems software given that applications software is unable to execute without the operating system and system utilities. Network applications are applications designed specifically for use with or through a network. Network applications include, but are not limited to, VoIP applications, including softphone applications, peer-to-peer and other file transfer applications, gaming software, and business applications. “Applications” and “network applications” are used interchangeably herein.

Applications are typically executed by a client. A client can be a desktop computer, a notebook, a PDA, or any other processing device that is capable of connecting to a network. A network, or network system, is a group of two or more computer systems linked together. According to embodiments of the invention, a network can be any known network including local area networks (LANs), virtual LANs, (VLANs) wide area networks (WANs), campus area networks (CANs), metropolitan area networks (MANs), wireless networks and the like.

By classifying traffic at the application level, a network system can accurately control the flow of network traffic based on the network topology and the applications using the network. As used herein, “classifying” traffic refers to any form of classifying, designating, assigning, identifying, and/or marking packet traffic known in the art for the purpose of providing QoS to the packet traffic.

In one embodiment, the system monitors every socket that is opened on a particular client by an application. A socket is a software object that connects an application to a network protocol (e.g., TCP or UDP). In one embodiment, a socket is a “5-tuple,” meaning the socket is defined by source and destination IP addresses, source and destination ports, and protocol. In another embodiment, a socket is a “3-tuple,” or listening socket, meaning the socket is defined by the protocol, port, and listening IP address.

A socket address is typically defined by combining the IP address of the client with a particular port number. Socket monitoring is done by tracking the process ID that opens a socket, from which the identity of the application can be obtained. At the moment an application opens a socket, the system checks this application against a QoS policy to determine what level of service that application should receive. In one embodiment, the level of service is determined based on the characteristics of the application itself. In another embodiment, the level of service is determined based on a combination of the application characteristics and a characterization of the socket opened by the application. After the level of service has been determined and assigned, a packet scheduler (or similar device) may schedule packets originating from the application for network transmission based on the socket being used and the assigned QoS level for the socket/application.

This method of classifying traffic is not dependent on applications being QoS aware/enabled. However, for those applications that are QoS aware and that attempt to mark their own packets according to a self-designated QoS level, embodiments of the present invention will override those markings in accordance with the established QoS policy.

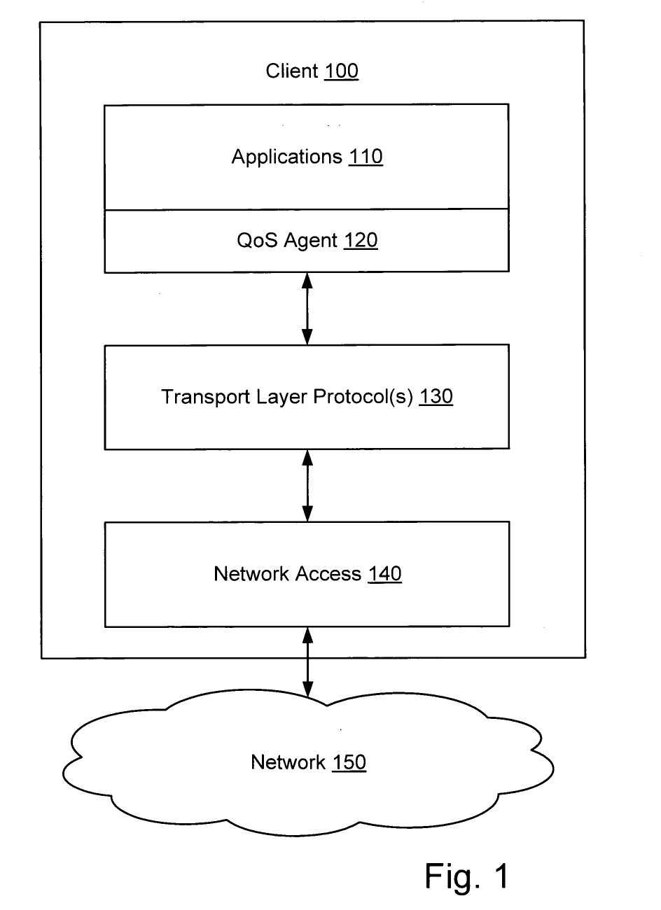

FIG. 1 illustrates an embodiment of the invention. A client 100 is communicatively coupled to a network 150. The client executes one or more applications 110 that require a network connection (e.g. soft-phone, email client, internet browser, peer-to-peer application, etc.). Client 100 includes a QoS agent 120 that acts as a layer between the applications 110 and the transport layer protocols 130. QoS agent 120 is accessible by a network administrator and allows for mapping of QoS policies. The administrator can assign QoS values specific to each application rather than assigning values based solely on a port number. In other words, the QoS agent 120 receives QoS values for different applications as part of a QoS policy. These values may be tailored based on the application type and/or other local considerations relating to network conditions. In another embodiment, the QoS values can be automatically assigned based on a set of defined algorithms.

QoS agent 120 is endowed with the capability to monitor socket connections. Whenever an application 110 opens a new socket, QoS agent 120 checks the application against the QoS policy to determine what type of service to give packets sent by the application. In one embodiment, QoS agent 120 marks/tags packets corresponding to the application based on the socket address used by the application. For example, QoS agent 120 may detect a soft-phone application opening a new socket and determine, based on the QoS policy, that the soft-phone application is a high priority application. Thus, QoS agent 120 will mark/tag all packets sent via the socket (corresponding to the soft-phone application) with a marking that reflects the high priority status.

Packets originating from a particular application can be marked using various markings and/or tags. In one embodiment, packets are assigned an Open Systems Interconnection (OSI) Layer 2 (Ethernet) tag. A Layer 2 QoS tag, as used herein, is synonymous with “class of service.” One example of a Layer 2 QoS tag is an Institute of Electrical & Electronics Engineers (IEEE) 802.1P tag. 802.1P defines eight (8) classes of traffic. In another embodiment, packets are assigned an OSI Layer 3 (IP) tag. A Layer 3 QoS tag, as used herein, is synonymous with “type of service.” One example of a Layer 3 QoS tag is a DiffServ tag, known as a DiffServ Code Point (DSCP). DiffServ supports up to sixty-four (64) levels of classification. Other types of tags/marks known in the art may also be used in accordance with an embodiment of the invention.

In addition to priority/classification tags, applications may be assigned a specified network bandwidth. In one embodiment, applications are each assigned a bandwidth token that defines a guaranteed minimum rate at which the application is able to send traffic. In another embodiment, applications are each assigned a bandwidth limit. In yet another embodiment, applications are assigned a combination of both the bandwidth limit and the bandwidth token.

Once packets have been marked by QoS agent 120, they are passed through the Transport Layer 130 and the Network Access Layer 140 before reaching network 150.

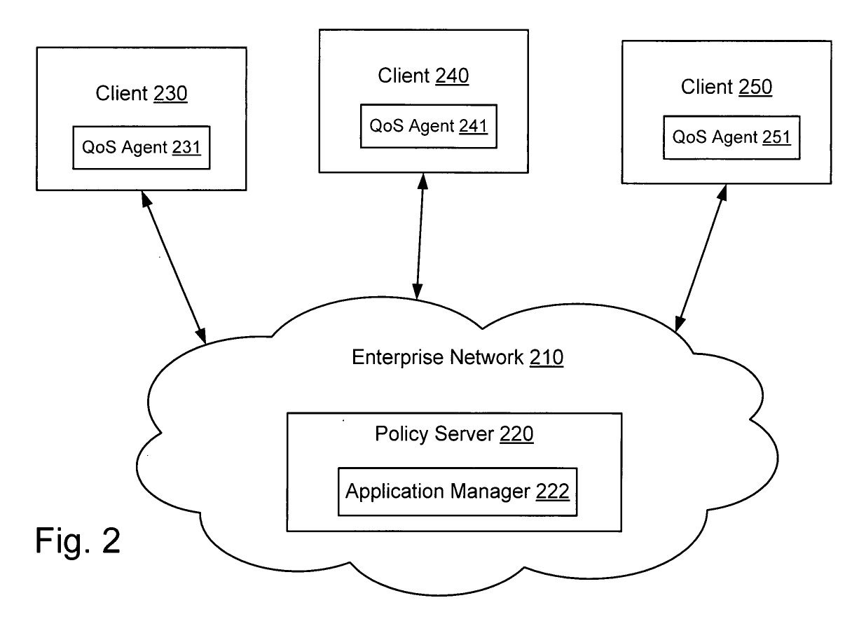

FIG. 2 illustrates an embodiment of the invention that includes a policy server 220. Policy server 220 provides centralized management of clients 230, 240, and 250 on enterprise network 210. Policy server 220 is responsible for distributing QoS policy for enterprise 210 to clients 230, 240, and 250. Policy server 220 includes an application manager 222 that allows a network administrator to define QoS values for specific applications from a central location.

In one embodiment, policy server 220 (including application manager 222) operates within the framework of Group Policy technology, available from Microsoft Corporation, of Redmond, Wash. In this embodiment, an Active Directory allows network administrators to assign enterprise-wide policies, deploy programs to clients, and apply critical updates to an entire organization. In other embodiments, a separate dedicated QoS policy system could be implemented.

In one embodiment, application manager 222 includes a graphical user interface (GUI) that allows a network administrator to select applications and edit/modify/assign QoS values for various applications. In one embodiment, only an administrator with access to application manager 222 can create or modify the QoS policy. For example, an administrator may select to modify QoS values for a soft-phone application, an email client application, a system backup application (e.g. Total Lifecycle Management (TLM)), or other application. After selecting an application, the administrator selects a value for one or more QoS tags (e.g., Layer 2 tags, Layer 3 tags, etc.). These tags determine the level of priority for packet transmission from the selected application. Additionally, the administrator may also select a minimum guaranteed bandwidth value and/or a bandwidth maximum value for the application's traffic. Once the QoS policy has been created/modified for the application(s), policy server 220 distributes the policy to enterprise clients 230, 240, and 250. In one embodiment, policy server 220 distributes the policy to all of the clients on the enterprise. In another embodiment, policy server 220 distributes the policy to a select number of enterprise clients. In addition, policy server may send the same policy to each of the clients in one embodiment, while sending different policies to different clients in another embodiment. In each case, the respective QoS agents 231, 241, and 251 at each client receive the QoS values distributed by policy server 220 for implementation. In one embodiment, the QoS policy is not accessible to clients 230, 240, and 250 in order to prevent an end user from altering or otherwise modifying the QoS values received by QoS agents 231, 241, and 251.

QoS agents 231, 241, and 251 apply the QoS policy to applications running on clients 230, 240, and 250, respectively. Whenever an application executing on client 230 opens a new socket/connection, QoS agent 231 identifies the application and compares it against the received QoS policy. In one embodiment, QoS agent 231 detects the opening of a new socket and identifies the application, for example, as an Internet browser. By comparing the application against the QoS policy, QoS agent 231 may determine that the Internet browser is a low priority application. Given this information, all packets originating from the Internet browser, sent via the socket, will be marked according to the corresponding low priority QoS values in the QoS policy.

In another embodiment, an application (e.g. soft-phone) may connect to the enterprise network using different ports on each of clients 230, 240, and 250. In order to ensure identification accuracy, QoS agents 231, 241, and 251 each identify the application based on the socket address used by the application and not solely based on a pre-selected port. Thus, each instance of the application will be accurately identified at each respective client and will receive the appropriate level of QoS as defined by the QoS policy.

It is not necessary for a client to be “on-line” (i.e., connected) with policy server 220 for the QoS agent to apply the QoS policy to an application that opens a socket to connect to enterprise 210. Clients 230, 240, and 250 need only be on-line with policy server 220 for QoS agents 231, 241, and 251 to receive the distributed QoS policy. QoS agents 231, 241, and 251 can apply the QoS policy independent of any connection to policy server 220.

In another embodiment, QoS policy is used to mitigate harmful network traffic, including viruses. If a virus is caused by a specific application, the QoS policy for enterprise 210 can be modified to lower the priority of (or completely drop) traffic from the harmful application. This policy update is pushed to all clients on enterprise 210.

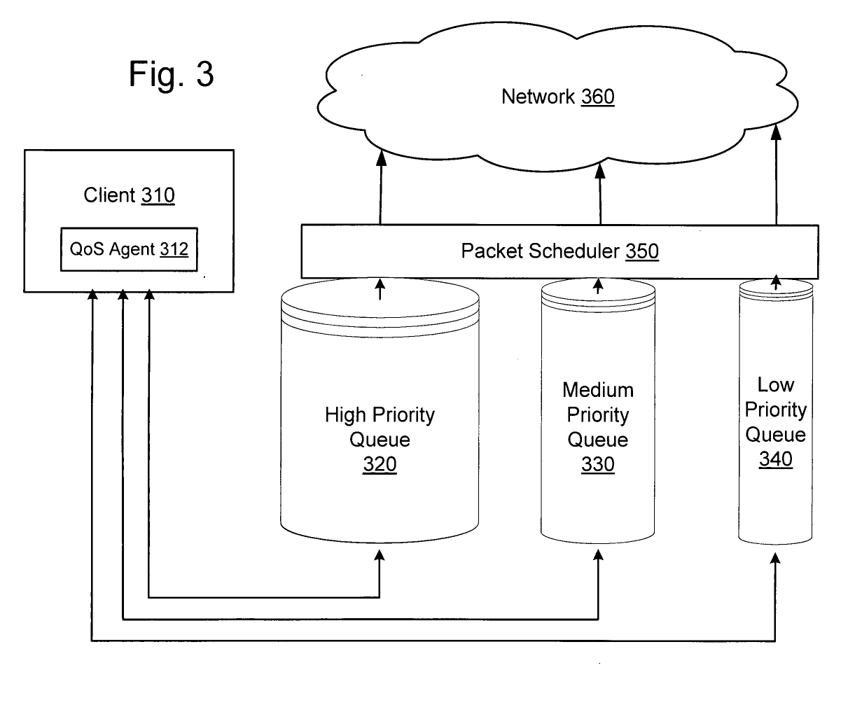

Another embodiment of the invention is shown in FIG. 3. Client 310 is configured to connect to network 360. QoS agent 312 detects an application opening a new socket for the purpose of sending packet data out on the network 360. When QoS agent 312 identifies the application that opened the socket, QoS agent 312 compares the application against a QoS policy. Based on the QoS policy, QoS agent 312 causes packets from the application to be placed into one of three priority queues 320, 330, and 340. In one embodiment, QoS agent 312 marks/tags the packets and places them into respective queues based on the tags. In another embodiment, QoS agent 312 simply places packets into queues based on the identity of the application sending the packets. For example, latency sensitive VoIP traffic may be placed into high priority queue 320. Meanwhile, normal traffic (e.g. email) is placed into medium priority queue 330 and low priority traffic is placed into low priority queue 340. One of skill in the art will appreciate that any number of queues can be used to prioritize traffic in accordance with an embodiment of the invention. The process of prioritizing traffic can also be referred to as “filtering.” Filtering includes prioritizing traffic (e.g., marking/tagging packets) for network transmission, but can also include marking traffic for the purpose of blocking and/or dropping packets. Once packets have been prioritized/filtered and/or placed into queues, packet scheduler 350 schedules the packets for transmission onto network 360.

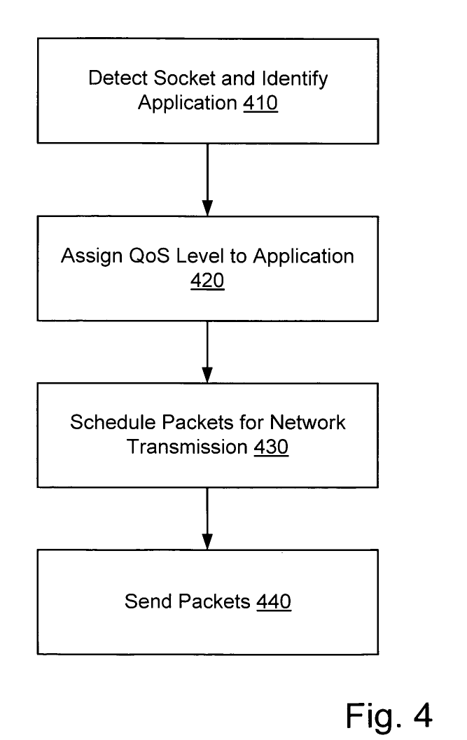

FIG. 4 is a flow diagram illustrating an embodiment of the invention. Many network applications use dynamic port allocation, meaning that a single application executing on a single client can open a different socket each time it seeks to connect to the network. In one embodiment, an application is identified directly by detecting the opening of a socket 410 on a client and securing a corresponding process ID that identifies the application.

Having identified the application, one or more QoS levels are assigned to the application 420. QoS levels can be assigned by tagging/marking packets sent via the socket opened by the application. Packets are tagged/marked with a priority level. Various types of priority schemes and/or tags can be used including, but not limited to Ethernet tags, IP tags, and the like. Any number of priority levels can be used in accordance with an embodiment of the invention. For example, 802.1P tags allow for eight (8) different levels of priority while DiffServ tags allow for up to sixty-four (64) different priority levels. Assigning QoS levels may also depend on both application and socket characteristics including, but limited to, protocol, source and destination ports, source and destination IP addresses, etc.

Assigning QoS levels may also include defining a bandwidth for traffic sent by an application. In one embodiment, QoS levels define a minimum guaranteed bandwidth for use by the application. In another embodiment, QoS levels define a maximum, or burst, bandwidth for use by the application.

Once QoS levels have been assigned to packets based on the application transmitting them, these packets are scheduled for transmission on the network 430. Thus, packets originating from high priority applications, such as latency sensitive applications (e.g. VoIP, video applications, etc.) will be given scheduling priority over packets originating from lower priority applications (e.g. TLM backups, peer-to-peer file sharing applications, etc.). The packets are then transmitted onto the network 440 according the scheduling.

Embodiments of the invention described above may include hardware, software, and/or a combination of these. In a case where an embodiment includes software, the software data, instructions, and/or configuration may be provided via an article of manufacture by a machine/electronic device/hardware. An article of manufacture may include a machine accessible/readable medium having content to provide instructions, data, etc. The content may result in an electronic device, for example, a filer, a disk, or a disk controller as described herein, performing various operations or executions described. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other forms of propagated signals (e.g., carrier waves, infrared signals, digital signals, etc.), etc. The machine accessible medium may further include an electronic device having code loaded on a storage that may be executed when the electronic device is in operation. Thus, delivering an electronic device with such code may be understood as providing the article of manufacture with such content described above. Furthermore, storing code on a database or other memory location and offering the code for download over a communication medium via a propagated signal may be understood as providing the article of manufacture with such content described above.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method, comprising:
establishing a Quality of Service (QoS) policy for an application, wherein the application is executable on a client of a network;
distributing the QoS policy to the client; and
filtering packets sent by the application based at least in part on the QoS policy.

2. The method of claim 1, wherein distributing the QoS policy comprises sending the QoS policy to a QoS agent on the client.

3. The method of claim 1, wherein filtering packets sent by the application comprises:
detecting a socket opened by the application;
applying the QoS policy to packets sent via the socket;

4. The method of claim 3, wherein filtering packets further comprises placing packets into prioritized transmission queues based at least in part on the QoS policy.

5. An apparatus, comprising:
a QoS agent to detect a socket opened by an application on a client and to apply a QoS policy to packets sent via the socket;
an application manager to send the QoS policy for the application to the QoS agent; and
a packet scheduler to schedule the packets for network transmission based at least in part on the applied QoS policy.

6. The apparatus of claim 5, wherein the application manager resides on a policy server.

7. The apparatus of claim 5, wherein the QoS policy for the application is exclusively controlled by a policy entity, wherein the policy entity is isolated from the client.

8. The apparatus of claim 5, wherein the QoS policy comprises a QoS tag.

9. The apparatus of claim 8, wherein the QoS tag is a IEEE 802.1P tag.

10. The apparatus of claim 8, wherein the QoS tag is a Differentiated Services (DiffServ) tag.

11. The apparatus of claim 8, wherein the QoS policy further specifies a bandwidth for sending the packets.

12. The apparatus of claim 8, wherein the QoS policy further specifies a maximum bandwidth for sending the packets.

13. An article of manufacture comprising a machine accessible medium having content stored thereon to provide instructions that cause a machine to perform operations including:
identifying a socket used by an application to connect to a network;
assigning a level of Quality of Service (QoS) to the socket; and
scheduling packets to be sent on the network by the application based on the QoS level assigned to the socket.

14. The article of manufacture of claim 13, wherein assigning a level of QoS to the socket comprises further instructions including assigning a priority level to the socket.

15. The article of manufacture of claim 13, wherein assigning a level of QoS to the socket comprises further instructions including assigning a bandwidth to packets sent via the socket.

16. The article of manufacture of claim 15, wherein assigning a bandwidth to packet sent via the socket comprises further instructions including assigning a maximum bandwidth to packets sent via the socket.

17. A system, comprising:
a processor to
detect a socket through which an application communicates over a network,
establish a QoS policy for packets sent via the socket, and
schedule the packets for network transmission based at least in part on the established QoS policy;
a memory coupled to the processor; and
a network interface card coupled to the processor to transmit scheduled packets over the network.

18. The system of claim 17, wherein the QoS policy comprises a QoS tag.

19. The system of claim 18, wherein the QoS policy further specifies a bandwidth for sending the packets.
